(19) United States
(12) Patent Application Publication
(10) Pub. No.: US 2012/0173873 A1
(43) Pub. Date: Jul. 5, 2012

(54) SMART GRID DEVICE AUTHENTICITY VERIFICATION

(76) Inventors: Ray Bell, Mill Valley, CA (US); Stephen Street, San Francisco, CA (US); Will Bell, Mill Valley, CA (US)

(21) Appl. No.: 12/984,521

(22) Filed: Jan. 4, 2011

(51) Int. Cl. H04L 9/32

(52) U.S. Cl. 713/156; 713/168; 713/176

(57) ABSTRACT

Methods and articles of manufacture are provided. Some embodiments are directed to smart grid device authenticity verification. In an exemplary embodiment a method is provided that generates a firmware package image for a device. The method goes on to manufacture a microcontroller using the image. A ship file is then generated with unique data associated to the device. A board is then manufactured and a board ship file generated. The device is then authenticated on a network using the two ship files and the firmware image. This Abstract is provided for the sole purpose of complying with the Abstract requirement rules. This Abstract is submitted with the explicit understanding that it will not be used to interpret or to limit the scope or the meaning of the claims.

### BACKGROUND OF THE INVENTION

With the smart grid's transformation of the electric system to a two-way flow of electricity and information, the information technology and telecommunications infrastructures have become critical to the energy sector infrastructure. While the digital smart grid can provide tremendous savings and optimizations in the generation, transmission, and distribution of electricity, it also represents a significant security concern that is subject to a wide variety of both physical and programmatic malicious attacks. Thus, there is a need for a digital smart grid security platform that provides secure, scalable, auditable, digital smart grid device registration and identity management services. There is also a need for secure and operationally simple smart grid device manufacturing and deployment processes.

### SUMMARY OF THE INVENTION

Methods and apparatus are provided for device authenticity verification. In one embodiment, a method is provided where a micro-controller ship file is received from a manufacturing facility. This ship file contains unique data that identifies a particular device. The method then stores the contents of the ship file in a storage device. A board ship file is then received from a board manufacturing facility, the board ship file containing unique identifying data, board data and first encryption data. This data is additionally stored on a storage device. The particular devices is then authenticated on a network using the micro-controller ship data and the board ship file. In another embodiment the first encryption data includes board ship file public key and a digital signature. In a still further embodiment, the device includes a secure memory and a manufacturing firmware image is stored within the smart grid device. In another embodiment, the manufacturing firmware package image includes smart grid firmware and operating system, and first digital certificate data. In still further embodiments, the smart grid firmware and operating system are signed with a code signing digital certificate. In other embodiments authentication includes directing the smart grid device to a registration authority to obtain a certificate. I still further embodiments, the registration authority receives a certificate singing request from the smart grid device. In some provided embodiments, the certificate signing request includes a digital signature, and the registration authority confirms the digital signature. In others, the smart grid device receives the certificate and transmits a confirmation message to the registration authority verifying the smart grid device's possession of the smart grid device's private key. In still further embodiments, the smart grid device authenticates to the smart grid network using the certificate. Other embodiments provide additional methods and devices.

### BRIEF DESCRIPTION OF THE DRAWINGS

Various embodiments taught herein are illustrated by way of example, and not by way of limitation, in the figures of the accompanying drawings, in which:

FIG. 1 is a block diagram illustrating an exemplary system, according to one exemplary embodiment;

FIG. 2 is a block diagram illustrating an exemplary smart grid device, according to one exemplary embodiment;

FIG. 3 is a block diagram illustrating an exemplary smart grid device manufacturing process, according to one exemplary embodiment;

FIG. 4 is a block diagram illustrating an exemplary smart grid device pre-manufacturing process, according to one exemplary embodiment;

FIGS. 5A-5B are sequence diagrams illustrating pre-manufacturing and manufacturing of an exemplary smart grid device, according to one exemplary embodiment;

FIG. 6 is a flowchart illustrating deploying an exemplary smart grid device, according to one exemplary embodiment; and

FIG. 7 illustrates sequence diagrams illustrating authenticating an exemplary smart grid device, according to one exemplary embodiment.

It will be recognized that some or all of the figures are schematic representations for purposes of illustration and do not necessarily depict the actual relative sizes or locations of the elements shown. The figures are provided for the purpose of illustrating one or more embodiments with the explicit understanding that they will not be used to limit the scope or the meaning of the claims.

### DETAILED DESCRIPTION OF THE PREFERRED EMBODIMENTS

Before turning to the figures which illustrate the exemplary embodiments in detail, it should be understood that the disclosure is not limited to the details or methodology set forth in the description or illustrated in the figures. It should also be understood that the terminology is for the purpose of description only and should not be regarded as limiting. Further, it should be understood that the use of the term “exemplary” refers to an example and does not imply importance in any respect.

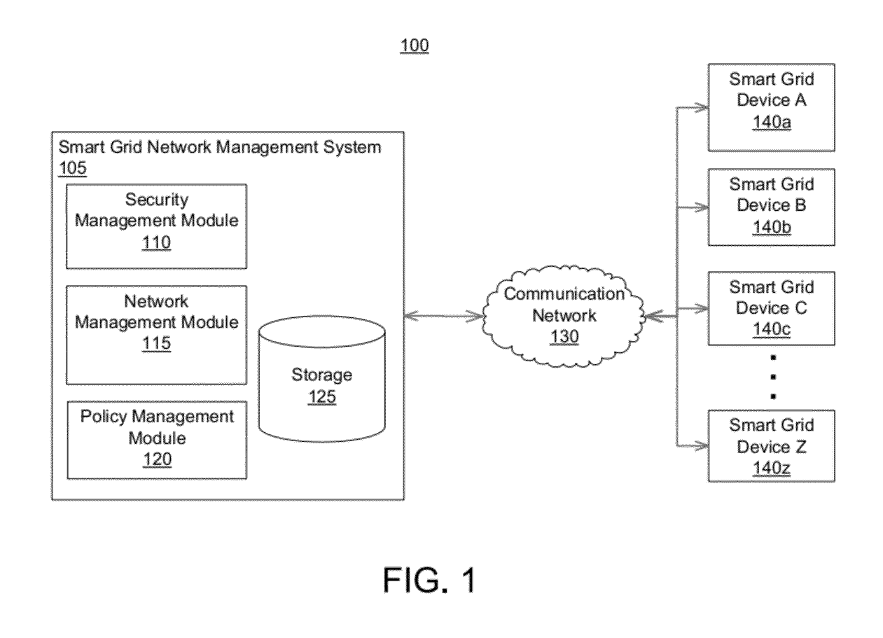

FIG. 1 illustrates an exemplary digital smart grid infrastructure 100 including a smart grid network management system 105, and smart grid devices A 140a through Z 140z (e.g., smart meter, smart router, etc.). Although not shown, the smart grid infrastructure 100 may include distributed generation sources, energy storage devices, smart SCADA devices, etc. In some embodiments, a single company (e.g., an electric utility that engages in generation, transmission, and/or distribution of electricity) operates the exemplary digital smart grid infrastructure 100. For example, the electric utility may use the smart grid network management system 105 to manage deployment and operation of the smart grid including smart grid devices (e.g., A 140a through Z 140z) such as smart meters and routers.

The digital smart grid infrastructure 100 includes a communication network 130 (e.g., Worldwide Interoperability for Microwave Access (WiMAX) network, internet protocol (IP) network, a local area network (LAN), wireless local area network (WLAN), internet, etc.). Although FIG. 1 illustrates a single communication network 130, the system can include a plurality of communication networks and/or the plurality of communication networks can be configured in a plurality of ways (e.g., a plurality of interconnected local area networks (LAN), a plurality of interconnected wide area network (WAN), a plurality of interconnected LANs and/or WANs, etc.).

The smart grid devices A 140a through Z 140z may include smart meters that record consumer electricity consumption. In some embodiments, the smart meters may monitor power quality. The smart meters may communicate the consumption levels back to the smart grid network management system 105 or another central system for electricity consumption management and billing. In some embodiments, the smart meters may send power outage notifications to the smart grid network management system 105 or another central system. The smart grid devices A 140a through Z 140z may communicate with the smart grid network management system 105 on a scheduled or ad hoc basis.

In some embodiments, consumers may be provided with a smart grid device interface (e.g., a user interface for a smart meter) to manage the smart grid device. For example, the user interface may include a web page that displays to the user consumption levels, and/or enables the user to customize power consumption (e.g., use less electricity during peak periods).

The smart grid network management system 105 may improve the reliability and efficiency of the smart grid. For example, the smart grid network management system 105 may manage the registration and operation of the smart grid devices 140a-140z. The smart grid network management system 105 may securely communicate with the smart grid devices 140a-140z (e.g., regarding consumer power consumption, power outages, etc).

The smart grid network management system 105 is shown to include a security management module 110, a network management module 115, a policy management module 120, and a storage 125. In some embodiments, the security management module 110 may use the public key infrastructure (PKI). In these embodiments, the security management module 110 may manage a registration authority server (not shown) which is an authority in a network that verifies smart grid device requests for a digital certificate. The security management module 110 may manage a certificate authority server (not shown) which issues the digital certificates enabling smart grid devices to securely exchange information with the smart grid network management system 105.

The network management module 115 manages the one or more networks in the smart grid. In some embodiments, the network management module may utilize the Dynamic Domain Name System (DDNS) protocol for naming services, computers, and devices connected to the network (e.g., Internet, private network, etc.). The network management module 115 may use the Dynamic Host Configuration Protocol (DHCP) which allows for automatic computer configuration. The network management module 115 may use the Network Time Protocol (NTP) for synchronizing the time on computers in the network.

The policy management module 120 may manage policies used by the smart grid devices A 140a through Z 140z and/or other resources connected to the network. In some embodiments, the policy management module 120 may manage one or more policy servers (e.g., using the Common Open Policy Services (COPS) protocol, COPS 00B, COPS-PR). In some embodiments, the policy management module 120 may use the Web Services Description Language (WSDL) and Common Information Model (CIM).

The storage device 125 may store network related data including data regarding the smart grid devices A 140a through Z 140z, an operating system and/or any other data or program code associated with the smart grid network management system 105. The storage device 125 can include a plurality of storage devices. The storage device can include, for example, long-term storage (e.g., a hard drive, a tape storage device, flash memory, etc.), short-term storage (e.g., a random access memory, a graphics memory, etc.), and/or any other type of computer readable storage. The storage device 125 may include secure storage for storing encryption key information and other sensitive information.

Although FIG. 1 illustrates the smart grid devices A 140a through Z 140z, the infrastructure 100 can include any number of smart grid devices. Although FIG. 1 illustrates the smart grid network management system 105, the infrastructure 100 can include other central control systems for controlling and managing the network and resources on the network such as the smart grid devices.

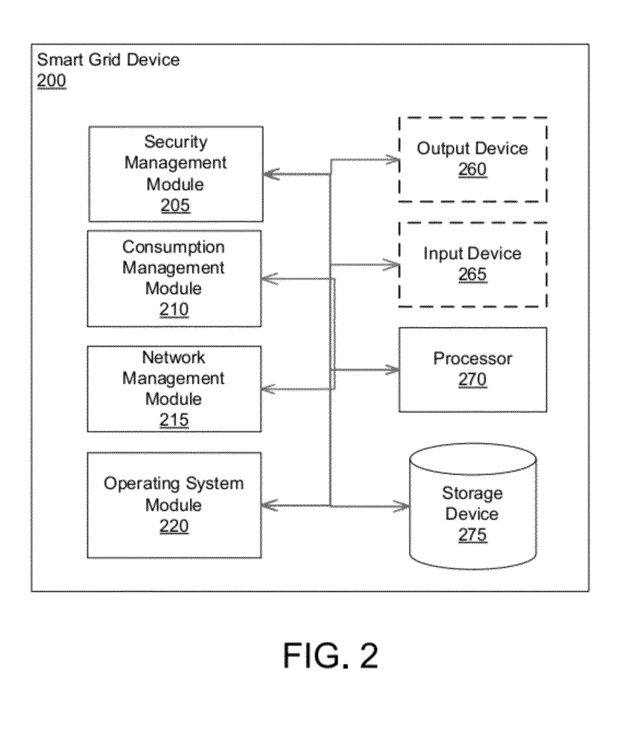

FIG. 2 illustrates an exemplary smart grid device 200. The smart grid device 200 includes a security management module 205, a consumption management module 210, a network management module 215, an operating system module 220, an output device 260, an input device 265, a processor 270, and a storage device 275. The modules and/or devices can be hardware and/or software. The modules and/or devices illustrated in the smart grid device 200 can, for example, utilize the processor 270 to execute computer executable instructions and/or include a processor to execute computer executable instructions (e.g., an encryption processing unit, a field programmable gate array processing unit, etc.). It should be understood that the smart grid device 200 can include, for example, other modules, devices, and/or processors known in the art and/or varieties of the illustrated modules, devices, and/or processors. It should be understood that the modules and/or devices illustrated in the smart grid device 200 can be located within the smart grid device 200 and/or connected to the smart grid device 200 (e.g., directly, indirectly, etc.).

The security management module 205 manages security of the smart grid device 200. In some embodiments, the security management module 205 may provide secure boot environment such that only signed user firmware can be run on the smart grid device 200. In these embodiments, the firmware may be signed using a private key which matches a public key stored in the smart grid device 200 (e.g., storage device 275). The security management module 205 may utilize the public key infrastructure (PKI) protocol to protect the smart grid device 200 from execution of unauthorized firmware or images. The security management module 205 may manage protection of sensitive data (e.g., encryption, storage in secure memory, etc.). The security management module 205 may perform tamper detection.

The consumption management module 210 monitors and manages electricity consumption. In some embodiments, the consumption management module 210 may communicate consumption measurements to the smart grid network management system 105 on a pre-set periodic or ad-hoc basis. The consumption management module 210 may store consumption measurements in the smart grid device 200 storage (e.g., storage device 275).

The network management module 215 manages communications with the grid network management system 105 and other resources on the network. The operating system module 220 operates an operating system on the smart grid device 200.

The output device 260 outputs information and/or data associated with the smart grid device 200 (e.g., information to a printer (not shown), etc.). The input device 265 receives information associated with the smart grid device 200 (e.g., instructions from a user, instructions from another resource on the network, etc.) from a user (not shown) and/or a computing system (not shown). The input device 265 can include, for example, a keyboard, a touch screen, etc.

The processor 270 executes the operating system and/or any other computer executable instructions for the smart grid device 200 (e.g., executes applications, etc.). The smart grid device 200 can include random access memory (not shown). The random access memory can temporarily store the operating system, the instructions, and/or any other data associated with the smart grid device 200. The random access memory can include one or more levels of memory storage (e.g., processor register, storage disk cache, main memory, etc.).

The storage device 275 stores the information associated with the smart grid device 200 including security sensitive data (e.g., key information, etc.), an operating system and/or any other data associated with the smart grid device 200 and/or the network. The storage device can include a plurality of storage devices. The storage device 675 can include, for example, long-term storage (e.g., a hard drive, a tape storage device, flash memory, etc.), short-term storage (e.g., a random access memory, a graphics memory, etc.), and/or any other type of computer readable storage.

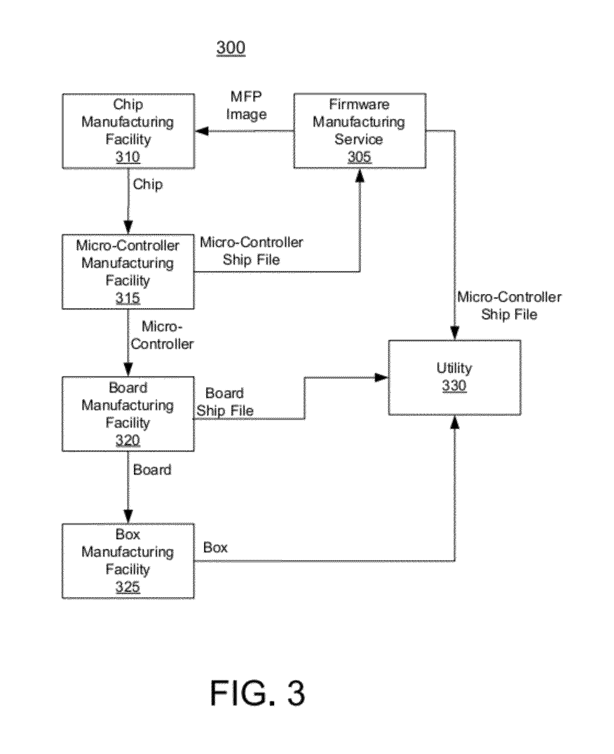

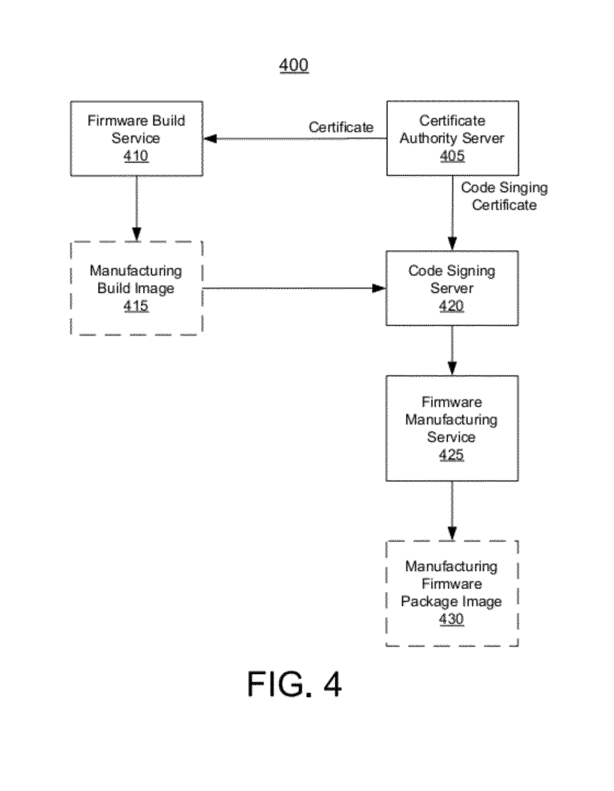

FIG. 3 illustrates an exemplary manufacturing process of secure smart grid devices (e.g., smart meters). A firmware manufacturing service 305 generates a manufacturing firmware package (“MFP”) image. FIG. 4 describes an exemplary process of generating the manufacturing firmware package image. In some embodiments, the MFP image may include the operating system and firmware for the device, certificate and key information for securely installing the firmware on the device and securely authenticating the device to the network.

A chip manufacturing facility 310 received the MFP image from the firmware manufacturing service 305. The chip manufacturing facility 310 pre-flashes the MFP image onto a chip (e.g., NAND chip, NOR chip, etc.). In some embodiments, the pre-flashed chips will be used to build a specific set of smart grid devices. The chip-manufacturing facility sends the pre-flashed chip to a micro-controller manufacturing facility 315.

During manufacturing of a micro-controller, the micro-controller chip's unique device identity may be written into the chip's memory (e.g., using fuse banks) The micro-controller may also be pre-programmed with a super-root key hash (e.g., a hash digest of certificate authority super root key public key). The micro-controller manufacturing facility 315 generates a micro-controller ship file. In some embodiments, a micro-controller ship file is generated for each micro-controller. In other embodiments, a single micro-controller ship file is generated for all the micro-controllers in a specific order. In some embodiments, the micro-controller ship file may include the unique device identity for each micro-controller chip in the manufacturing build. The generated micro-controller chip file may be encrypted using the firmware manufacturing service's 305 public key.

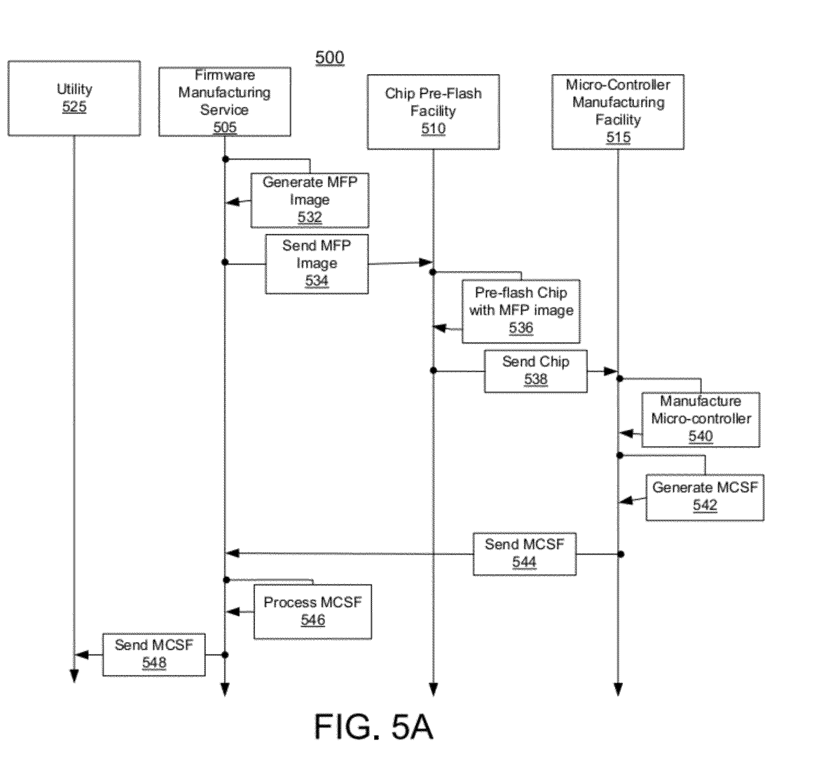

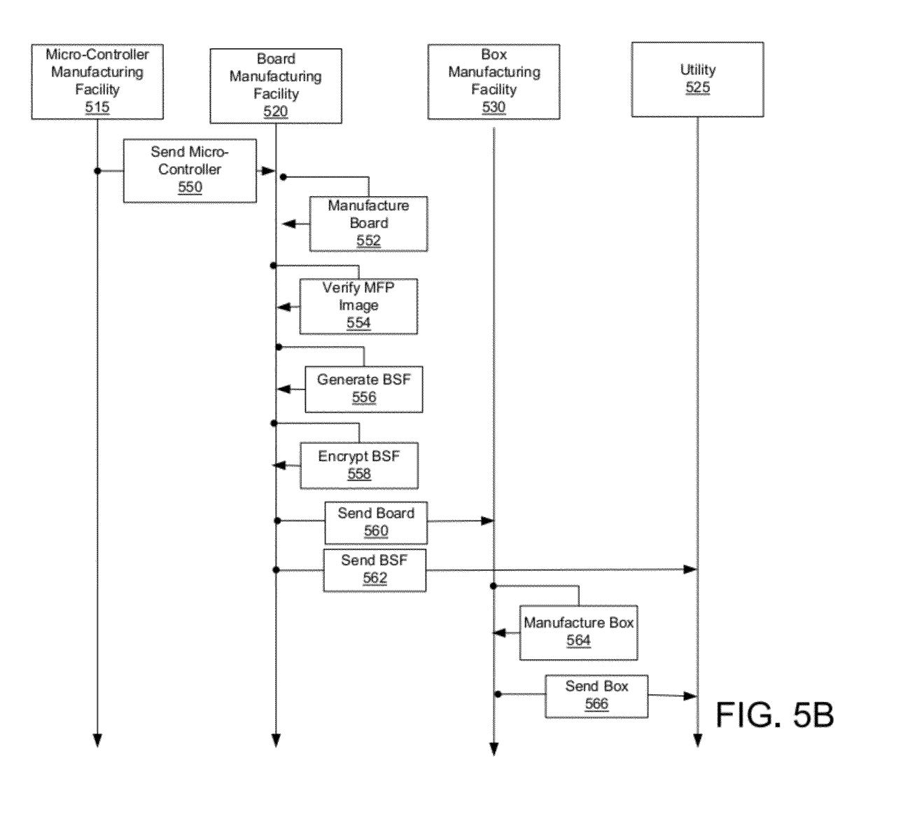

The generated micro-controller ship file is sent to the firmware manufacturing service 305 for further processing as illustrated in FIG. 5A. The firmware manufacturing service sends the re-processed micro-controller ship file to the utility 330. In other embodiments, the micro-controller manufacturing service 315 sends the micro-controller ship file directly to the utility 330. The manufactured micro-controller is sent to a board manufacturing facility 320.

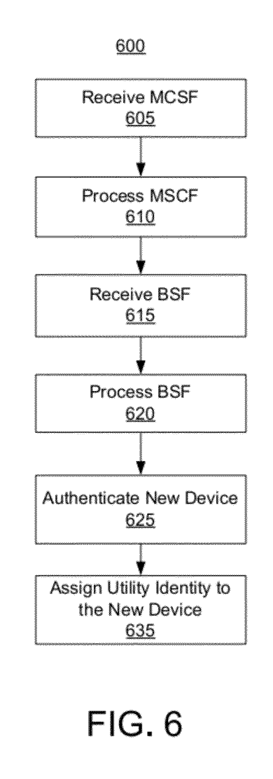

The board manufacturing facility 320 may manufacture a board using the manufactured micro-controller. During the manufacturing process, the board manufacturing facility 320 may generate a board ship file. In some embodiments, a single board ship file is generated for each purchase order by the utility 330. In other embodiments, one or more board ship files are generated for each board being manufactured. In some embodiments, the board ship file includes unique device identity, board information (e.g., board serial number), encryption information (e.g., board ship file public key, digital signature, etc.). In some embodiments, the manufactured board including the micro-controller chip is sent to a box manufacturing service for box manufacturing. In other embodiments, the manufactured board is delivered to the utility 330. As discussed in connection with FIG. 6, the utility 330 processes the received micro-controller ship file as well as the board ship file, and securely authenticates the manufactured smart grid device on the network.

FIG. 4 illustrates an exemplary pre-manufacturing process for generating firmware package images. As shown, a certificate authority server 405 may issue a certificate (e.g., WiMAX X.509 certificate) used for generating a manufacturing build image. The certificate authority server 405 may manage, generate, store, deploy, and revoke digital certificates. In some embodiments, the certificate authority server 405 is a component of the smart grid network management system 105. The certificate authority server 405 may operate in an offline-mode, and only come online when a new certificate needs to be issued.

The digital certificates are electronic files used to uniquely identify the resources (e.g., smart meters, routers, etc.) over networks and ensure secure communication between smart grid system components. In some embodiments, the generated certificates are product-specific code signing certificates. A digital certificate may include entity identifying information, certificate expiration period, entity's public key, serial number, and/or certificate authority's identifying information, etc. The certificate authority server 405 may sign the issued certificates with a private key corresponding to a Super Root Key (“SRK”) public key. The private key of the SRK may be stored within a software escrow account bank vault.

In some embodiments, the certificates generated by the certificate authority server 405 are WIMAX certificates (e.g., WIMAX X.509 certificates), Wireless Transport Layer Security (“WTLS”) certificates, etc. The issued certificate may allow a smart grid device to make an initial network entry prior to automated field provisioning. In some embodiments, the initial network entry may be insecure if the certificate privet key is not yet encrypted on the flash chips at this point in the process.

A firmware build service 410 generates a manufacturing build image (“MBI”) which may include smart grid agent firmware (i.e., programmable content of a device). In some embodiments, the smart grid agent firmware includes a network operating system. The certificate authority server 405 may issue a certificate (e.g., upon a request from the firmware build service 410). The manufacturing build image may include the certificate issued by the certificate authority server 405 and a public key and private key pair that is unique to the manufacturing build image. In some embodiments, the public and private key pair is generated by the firmware build service 410. In other embodiments, the public and private key pair is generated by the certificate authority server 405. Although not shown, the firmware build service 410 may generate a hash of the manufacturing build image using a secure hash algorithm (e.g., SHA-256 algorithm). In some embodiments, the hash of the manufacturing build image may be sent to a code signing server 420. In other embodiments, the generated manufacturing build image is sent to the code signing server 420 for further processing.

The code signing server 420 may request a code signing certificate from the certificate authority server 405. In response, the certificate authority server 405 may generate a code signing certificate (e.g., a WTLS certificate). In some embodiments, using the private key of the received code signing certificate, the code signing server 420 may digitally sign the manufacturing build image hash or the manufacturing build image.

As illustrated, using the manufacturing build image, a firmware manufacturing service 425 creates a manufacturing firmware package. In some embodiments, the manufacturing firmware package contains the manufacturing build image, the certificate along with the public/private key pair, the code signing server signed manufacturing build image, code signing certificate public key, and/or a command sequence file (e.g., containing a process instruction set for the micro-controller including signature and certificate information for the boot image). The manufacturing firmware package may further contain additional certificates and/or key information to ensure secure deployment of the device. As further illustrated in FIG. 5A, the generated manufacturing firmware package image is sent to a chip pre-flash facility.

In FIGS. 5A-5B, a sequence diagram relating to manufacturing of secure smart grid devices is shown, according to an exemplary embodiment. As illustrated in FIG. 4, the firmware manufacturing service 505 (i.e., 425) generates (step 532) a manufacturing firmware package image and sends (step 534) the manufacturing firmware package image to a chip pre-flash facility 510. At the chip pre-flash facility 510, the manufacturing firmware package image is pre-flashed (step 536) (i.e., written into memory) onto a chip (e.g., NAND chip, NOR chip, etc.) that will be used to build a specific smart grid device. The pre-flashed chips are packaged and sent (step 538) to a micro-controller manufacturing facility 515.

In some embodiments, micro-controller chips are manufactured on a specific order basis (e.g., a specific order from a utility or another entity). In some embodiments, a unique device identity of the micro-controller's chip is written into the chip's memory (e.g., user identity fuse bank). In some embodiments, the micro-controller chips are pre-programmed with a super-root key hash provided by the firmware manufacturing service that is written into the chip's super root key fuse bank which is then blown. During the manufacturing of a micro-controller chip, a micro-controller ship file is generated (step 542). In some embodiments, the micro-controller ship file may include the user identity fuse bank contents for each micro-controller chip in the manufacturing build. The micro-controller ship file may be encrypted using the PKCS digital envelope method and the firmware manufacturing service 505 software's public key. The micro-controller ship file may be delivered (step 544) to the firmware manufacturing service 505. At step 546, the encrypted micro-controller ship file is decrypted using the firmware manufacturing service 505 software's private key. In some embodiment, the decrypted micro-controller ship file may be encrypted using the utility's smart grid network management system software's public key. At step 548, the encrypted micro-controller ship file is delivered to the utility 525 through an out-of-band process. In other embodiments, the micro-controller ship file generated in step 542 may be delivered directly to the utility 525 without any further processing performed by the firmware manufacturing service 505.

As illustrated in FIG. 5B, the manufacturing micro-controller is sent (step 550) to a board manufacturing facility 520. The boards may be manufactured (step 552) with the pre-programmed micro-controller and the pre-flashed flash chipset. At step 554, a manufacturing built-in self test process may be initiated when the board is energized for the first time in order to verify the authenticity of a boot image. The pre-flashed image may be unpacked and the micro-controller may be brought up in a secure mode. In some embodiments, in the secure mode, the network operating system firmware using the security components of the micro-controller may generate a board ship file private and public key pair. The smart grid network operating system firmware may retrieve the device user identity from the user chip memory (e.g., from the identity fuse bank), personalize the board, and/or create a hash (e.g., SHA-256 hash) and digital signature (e.g., of the unique device identity, board serial number, WAN Mac address(es), and/or HAN Mac Addresses) using the board ship file private key. In some embodiments, the smart grid network operating system firmware may destroy the board ship file key pair after use.

In some embodiments, the board ship file may include information including unique device Id, board serial number, WAN Mac Address(es), HAN Mac Address(es), board ship file public key, digital signature, and any other information associated with the board. At the end of the manufacturing process for each purchase order, the board ship file, containing a data record entry for each smart grid device board manufactured, may be encrypted with the utility's network management system software's public key. The encrypted board ship file is sent (step 562) out-of-band to the utility 525. At step 560, the manufactured board is sent to a box manufacturing facility which in turn manufactures (step 564) a box and sends (step 566) the box to the utility.

In FIG. 6 a flowchart 600 relating to deployment of an exemplary smart grid device is shown, according to an exemplary embodiment. The smart grid network management system 105 receives (step 605) the encrypted micro-controller ship file. At step 610, the smart grid network management system 105 decrypts the encrypted micro-controller ship file using its private key. The smart grid network management system 105 may load the contents of the micro-controller ship file into secure data storage (e.g., storage 125).

The smart grid network management system 105 receives (step 615) the encrypted board ship file and decrypts (step 620) the encrypted board ship file. The smart grid network management system 105 may store the contents of the board ship file into secure storage (e.g., storage 125).

In some embodiments, when a smart grid device is energized, it may attempt to create an authenticated network connection (e.g., using EAP/TLS protocols, PKMv2 protocols, etc.). For example, the smart grid device may scan to establish an air link (e.g., a WIMAX air link) to a base station (e.g., WiMAX base station). In some embodiments, the smart grid device may use the manufacturing build image certificate (i.e., certificate generated during pre-manufacturing process described in FIG. 4).

Upon initial authentication, the smart grid network management system 105 may quarantine the smart grid device by assigning it an IP address and a service profile that only permits remote communication with a registration authority server (e.g., registration authority server 150). In some embodiments, the registration authority server is a component of smart grid network management system 105. In secure mode, the smart grid network operating system firmware and the security management module 205 may generate a unique smart grid device private and public key pair. The generated keys may be stored in plaintext in secure storage of the smart grid device (e.g., secure RAM which would be accessible to the security management module 205 or another module of the smart grid device). In some embodiments, the generated smart grid device key pair may be encrypted by the security management module 205 of the smart grid device (e.g., using TDEA algorithm with the key stored by the smart grid device), and then stored off-chip in non-volatile memory in the smart grid device secure key store. In these embodiments, the smart grid device secure key store may only be decrypted by the security management module 205 of the smart grid device that created the encrypted key store file.

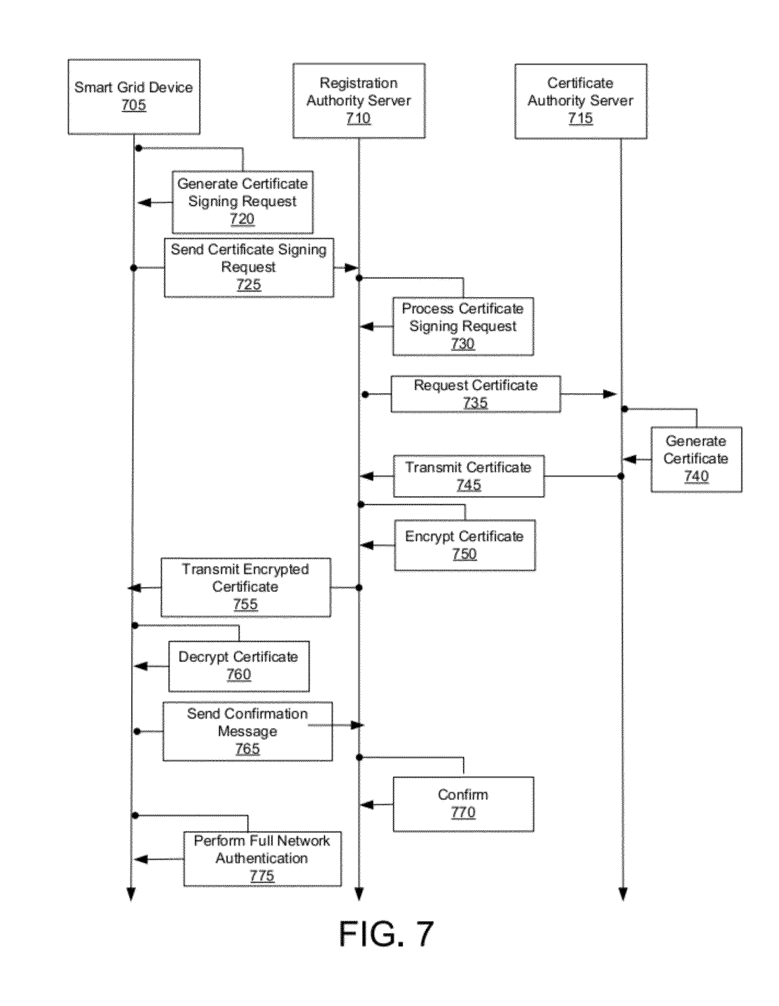

In FIG. 7, a sequence diagram relating to authenticating the smart grid device to the network is shown, according to an exemplary embodiment. At step 720, the smart grid device 705 generates a certificate signing request. In some embodiments, the certificate signing request may contain a request header and a request body. The header may contain the unique device identity. The certificate signing request body may contain the WAN Mac Address, the generated smart grid device public key, and/or body digital signature. In some embodiments, the header and body of the certificate signing request are hashed (e.g., SHA-256 hashed) and encrypted with the smart grid device private key to create a digital signature. In these embodiments, the certificate signing request header, body and digital signature may be encrypted using a registration authority public key (e.g., using a public key cryptography standard (“PKCS”) digital envelope method). At step 725, the smart grid device sends the encrypted certificate signing request (e.g., over Transport Layer Security protocol or Secure Socket Layer protocol) to a registration authority server 710. In some embodiments, the registration authority server is a component of the smart grid network management system 105.

At step 730, the registration authority server 710 processes the received certificate signing request. In some embodiments, the registration authority server 710 decrypts the received digital envelope using a registration authority private key. In these embodiments, the registration authority server 710 may decrypt the digital envelope using the PKCS digital envelope method. In order to verify the digital signature of the certificate signing request, the registration authority server 710 may decrypt the digital signature using the smart grid public key to expose the hash. The registration authority server 710 may calculate a plain-text certificate signing request header and body hash (e.g., SHA-256 hash) and compare it to the hash exposed when the digital envelope was decrypted.

Upon digital signature verification, the registration authority server 710 may request (step 735) that a certificate authority server 715 issue a smart grid certificate for the smart grid device (e.g., an X.509 certificate). In response to the certificate request, the certificate authority server 715 issues (step 740) a certificate and transmits (step 745) the generated certificate back to the registration authority server 710. At step 750, the registration authority 710 may encrypt the certificate using the public key of the smart grid device 705. The certificate may be encrypted using the PKCS digital envelope method.

The registration authority server 710 transmits (step 755) the encrypted certificate to the smart grid device 705. At step 760, the smart grid device 705 may decrypt the received certificate using the smart grid device private key. At step 765, the smart grid device 705 returns a confirmation message to the registration authority 710 confirming its proof of possession of the smart grid device private key. In some embodiments, the confirmation message may contain information according to a public key infrastructure certificate management protocol. At step 770, the registration authority server 710 confirms that the smart grid device possesses the smart grid device private key. If the smart grid device private key possession confirmation fails, the registration authority server may revoke the newly issued certificate.

In some embodiments, the smart grid device 705 may destroy the no longer needed manufacturing build image certificate and the public/private key pair issued during the pre-manufacturing process. At step 775, the smart grid device 705 disconnects from the network and performs a secure full network authentication using its newly issued smart grid device certificate (e.g., X.509 certificate). During the full network authentication, the smart grid device 705 may receive an IP address and a service profile from the smart grid network management system 105 which allows the smart grid device to access its authorized smart grid services.

Using the manufacturing and deployment processes described above, the customer-specific smart grid device identity may be fully protected. In some embodiments, the smart grid device key pair and the smart grid device certificate may be used indefinitely across power outages or un-trusted zone transit (truck, shop, warehouse, etc.) to provide secure identity services. The customer (i.e., utility) security policy may warrant periodic or ad-hoc updates of the smart grid devices' key pairs and/or smart grid device certificates.

If network authentication fails, or proof of private key possession by the smart grid device 705 fails, the smart grid network system 105 may send a disconnect message to disconnect the smart grid device from the air link (e.g., WiMAX link) and log the disconnect due to unauthorized logic or private key possession failures. In some embodiments, the smart grid network management system 105 may issue an alert of the disconnect to registered consumers (e.g., SOAP, SMS, email) according to the monitory policy configurations. The certificate authority may log certificate issuance and renewal. In some embodiments, the certificate authority may issue alerts of repeated certificate signing requests and renewals to registered consumers (e.g., SOAP, SMS, email) according to monitor policy configurations.

Once the smart grid device 705 successfully authenticates itself to the network, the smart grid device and smart grid network management system and its associated server may mutually verify each other's certificates (e.g., using the Online Certificate Status Protocol).

The above-described systems and methods can be implemented in digital electronic circuitry, in computer hardware, firmware, and/or software. The implementation can be as a computer program product (i.e., a computer program tangibly embodied in an information carrier). The implementation can, for example, be in a machine-readable storage device, for execution by, or to control the operation of, data processing apparatus. The implementation can, for example, be a programmable processor, a computer, multiple computers, and/or a micro-controller.

A computer program can be written in any form of programming language, including compiled and/or interpreted languages, and the computer program can be deployed in any form, including as a stand-alone program or as a subroutine, element, and/or other unit suitable for use in a computing environment. A computer program can be deployed to be executed on one computer or on multiple computers at one site.

Method steps can be performed by one or more programmable processors executing a computer program to perform the various functions by operating on input data and generating output. Method steps can also be performed by and an apparatus can be implemented as special purpose logic circuitry. The circuitry can, for example, be a FPGA (field programmable gate array) and/or an ASIC (application-specific integrated circuit). Modules, subroutines, and software agents can refer to portions of the computer program, the processor, the special circuitry, software, and/or hardware that implements that functionality.

Processors suitable for the execution of a computer program include, by way of example, both general and special purpose microprocessors, and any one or more processors of any kind of digital computer. Generally, a processor receives instructions and data from a read-only memory or a random access memory or both. The essential elements of a computer are a processor for executing instructions and one or more memory devices for storing instructions and data. Generally, a computer can be operatively coupled to receive data from and/or transfer data to one or more mass storage devices for storing data (e.g., magnetic, magneto-optical disks, or optical disks).

Data transmission and instructions can also occur over a communications network. Information carriers suitable for embodying computer program instructions and data include all forms of non-volatile memory, including by way of example semiconductor memory devices. The information carriers can, for example, be EPROM, EEPROM, flash memory devices, magnetic disks, internal hard disks, removable disks, magneto-optical disks, CD-ROM, and/or DVD-ROM disks. The processor and the memory can be supplemented by, and/or incorporated in special purpose logic circuitry.

To provide for interaction with a user, the above described techniques can be implemented on a computer having a display device. The display device can, for example, be a cathode ray tube (CRT) and/or a liquid crystal display (LCD) monitor. The interaction with a user can, for example, be a display of information to the user and a keyboard and a pointing device (e.g., a mouse or a trackball) by which the user can provide input to the computer (e.g., interact with a user interface element). Other kinds of devices can be used to provide for interaction with a user. Other devices can, for example, be feedback provided to the user in any form of sensory feedback (e.g., visual feedback, auditory feedback, or tactile feedback). Input from the user can, for example, be received in any form, including acoustic, speech, and/or tactile input.

The above described techniques can be implemented in a distributed computing system that includes a back-end component. The back-end component can, for example, be a data server, a middleware component, and/or an application server. The above described techniques can be implemented in a distributing computing system that includes a front-end component. The front-end component can, for example, be a client computer having a graphical user interface, a Web browser through which a user can interact with an example implementation, and/or other graphical user interfaces for a transmitting device. The components of the system can be interconnected by any form or medium of digital data communication (e.g., a communication network). Examples of communication networks include a local area network (LAN), a wide area network (WAN), the Internet, wired networks, and/or wireless networks.

The system can include clients and servers. A client and a server are generally remote from each other and typically interact through a communication network. The relationship of client and server arises by virtue of computer programs running on the respective computers and having a client-server relationship to each other.

The communication networks can include, for example, packet-based networks and/or circuit-based networks. Packet-based networks can include, for example, the Internet, a carrier internet protocol (IP) network (e.g., local area network (LAN), wide area network (WAN), campus area network (CAN), metropolitan area network (MAN), home area network (HAN)), a private IP network, an IP private branch exchange (IPBX), a wireless network (e.g., radio access network (RAN), 802.11 network, 802.16 network, general packet radio service (GPRS) network, HiperLAN), and/or other packet-based networks. Circuit-based networks can include, for example, the public switched telephone network (PSTN), a private branch exchange (PBX), a wireless network (e.g., RAN, Bluetooth, code-division multiple access (CDMA) network, time division multiple access (TDMA) network, global system for mobile communications (GSM) network), and/or other circuit-based networks. The communication networks can include a WiMAX network.

The smart grid device can include, for example, a computer, a computer with a browser device, a telephone, an IP phone, a mobile device (e.g., cellular phone, personal digital assistant (PDA) device, laptop computer, electronic mail device), and/or other communication devices. The browser device includes, for example, a computer (e.g., desktop computer, laptop computer) with a world wide web browser (e.g., Microsoft® Internet Explorer® available from Microsoft Corporation, Mozilla® Firefox available from Mozilla Corporation). The mobile computing device includes, for example, a personal digital assistant (PDA).

Comprise, include, and/or plural forms of each are open ended and include the listed parts and can include additional parts that are not listed. And/or is open ended and includes one or more of the listed parts and combinations of the listed parts.

As used in this application, the terms “component,” “module,” “system,” and the like are intended to refer to a computer-related entity, either hardware, firmware, a combination of hardware and software, software, or software in execution. For example, a component can be, but is not limited to being, a process running on a processor, an integrated circuit, an object, an executable, a thread of execution, a program, and/or a computer. By way of illustration, both an application running on a computing device and the computing device can be a component. One or more components can reside within a process and/or thread of execution and a component can be localized on one computer and/or distributed between two or more computers. In addition, these components can execute from various computer readable media having various data structures stored thereon. The components can communicate by way of local and/or remote processes such as in accordance with a signal having one or more data packets (e.g., data from one component interacting with another component in a local system, distributed system, and/or across a network such as the Internet with other systems by way of the signal).

Moreover, various functions described herein can be implemented in hardware, software, firmware, or any combination thereof. If implemented in software, the functions can be stored on or transmitted over as one or more instructions or code on a computer-readable medium. Computer-readable media is non-transitory in nature and includes both computer storage media and communication media including any medium that facilitates transfer of a computer program from one place to another. A storage media can be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any physical connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc (BD), where disks usually reproduce data magnetically and discs reproduce data optically with lasers. Combinations of the above should also be included within the scope of computer-readable media.

Additionally, in the subject description, the word “exemplary” is used to mean serving as an example, instance, or illustration. Any embodiment or design described herein as “exemplary” is not necessarily to be construed as preferred or advantageous over other embodiments or designs. Rather, use of the word exemplary is intended to present concepts in a concrete manner.

One skilled in the art will realize the provided embodiments may be embodied in other specific forms without departing from the spirit or essential characteristics thereof. The foregoing embodiments are therefore to be considered in all respects illustrative rather than limiting of the invention described herein. Scope of the invention is thus indicated by the appended claims, rather than by the foregoing description, and all changes that come within the meaning and range of equivalency of the claims are therefore intended to be embraced therein.

What is claimed is:

1. A smart grid device manufactured by a process comprising the steps of:
generating a manufacturing firmware package image for the smart grid device;
manufacturing a micro-controller using the manufacturing firmware package image;
generating a micro-controller ship file containing unique device identity data for the device;
manufacturing a board using the manufactured micro-controller;
generating a board ship file containing unique device identity data, board data, and encryption data;
manufacturing a box for the smart grid device using the manufactured board; and
authenticating the smart grid device to a smart grid network using the micro-controller ship file, the board ship file, and the manufacturing firmware package image.

2. The smart grid device of claim 1, wherein the manufacturing firmware package image includes smart grid firmware and operating system, and first digital certificate data.

3. The smart grid device of claim 1, wherein the smart grid firmware and operating system are signed with a code signing digital certificate.

4. The smart grid device of claim 1, wherein the authenticating step includes directing the smart grid device to a registration authority to obtain a certificate.

5. The smart grid device of claim 4, wherein the registration authority receives a certificate signing request from the smart grid device.

6. The smart grid device of claim 5, wherein the certificate signing request includes a digital signature, and the registration authority confirms the digital signature.

7. The smart grid device of claim 4, wherein the smart grid device receives the certificate and transmits a confirmation message to the registration authority verifying the smart grid device's possession of the smart grid device's private key.

8. The smart grid device of claim 4, wherein the smart grid device authenticates to the smart grid network using the certificate.

9. A method for authenticating a device to a network, the method comprising:
receiving a micro-controller ship file from a micro-controller manufacturing facility, the micro-controller ship file containing unique device identity data;
storing contents of the micro-controller ship file in a storage device;
receiving a board ship file from a board manufacturing facility, the board ship file containing unique device identity data, board data, and first encryption data;
storing contents of the board ship file in the storage device; and
authenticating the device to the network using the micro-controller ship file and the board ship file.

10. The method of claim 9, wherein the first encryption data includes board ship file public key and digital signature.

11. The method of claim 9, wherein secure memory of the smart grid device stores a manufacturing firmware package image.

12. The method of claim 11, wherein the manufacturing firmware package image includes smart grid firmware and operating system, and first digital certificate data.

13. The method of claim 12, wherein the smart grid firmware and operating system are signed with a code signing digital certificate.

14. The method of claim 9, wherein the authenticating step includes directing the smart grid device to a registration authority to obtain a certificate.

15. The method of claim 14, wherein the registration authority receives a certificate singing request from the smart grid device.

16. The method of claim 15, wherein the certificate signing request includes a digital signature, and the registration authority confirms the digital signature.

17. The method of claim 16, wherein the smart grid device receives the certificate and transmits a confirmation message to the registration authority verifying the smart grid device's possession of the smart grid device's private key.

18. The method of claim 14, wherein the smart grid device authenticates to the smart grid network using the certificate.

19. A smart grid device manufactured by a process comprising the steps of:
generating a manufacturing firmware package image for the smart grid device, the manufacturing firmware package image including smart grid firmware and operating system, and first digital certificate data;
manufacturing a micro-controller using the manufacturing firmware package image;
generating a micro-controller ship file containing unique device identity data for the smart grid device;
manufacturing a board using the manufactured micro-controller;
generating a board ship file containing unique device identity data, board data, and encryption data;
manufacturing a box for the smart grid device using the manufactured board;
authenticating the smart grid device to a smart grid network using the micro-controller ship file, the board ship file, and a certificate generated by a certificate authority upon request from the smart grid device; and
wherein the certificate request from the smart grid device includes the unique device identity, a smart grid device private key, and a digital signature.

20. The smart grid device of claim 19, wherein the smart grid device generates the smart grid device private key and a smart grid device public key.
